(19) United States
(12) Patent Application Publication
(10) Pub. No.: US 2021/0255145 A1
(43) Pub. Date: Aug. 19, 2021

(54) SYSTEM FOR INSPECTING A REPAIR OR JOINT CONSISTING OF A COMPOSITE MATERIAL APPLIED TO A STRUCTURE

(71) Applicants: PETROLEO BRASILEIRO S.A. - PETROBRAS, Rio de Janiero (BR); UNIVERSIDADE FEDERAL DE SANTA CATARINA - UFSC, Florianopolis (BR)

(72) Inventors: Walter ANTONIO KAPP, Curitiba (BR); Valber AZEVEDO PERRUT, Rio de Janeiro (BR); Sergio DAMASCENO SOARES, Petropolis (BR); Mauro EDUARDO BENEDET, Sao Jose (BR); James UBIRAJARA NOGUEIRA, Florianopolis (BR); Gustavo EMMENDOERFER, Curitiba (BR); Fabio APARECIDO ALVES DA SILVA, Florianopolis (BR); Daniel PEDRO WILLEMANN, Laguna (BR); Armando ALBERTAZZI GONCALVES JUNIOR, Florianopolis (BR); Analucia VIEIRA FANTIN, Florianopolis (BR); Ana Lucia FAMPA SEABRA D ALMEIDA, Rio De Janeiro (BR)

(21) Appl. No.: 17/251,270

(22) PCT Filed: Jun. 13, 2019
(86) PCT No.: PCT/BR2019/050222

§ 371 Date: Dec. 11, 2020

(30) Foreign Application Priority Data
Jun. 15, 2018 (BR) BR 102018012268-1

(51) Int. Cl. G01N 29/04; G01N 25/72; G01N 29/24; G01N 29/34; B29C 65/82; B29C 65/00

(52) U.S. Cl. CPC G01N 29/04; G01N 25/72; G01N 29/2437; G01N 29/348; B29C 65/8261; B29K 2309/08; B29C 66/1282; B29C 66/7212; G01N 2291/0289; G01N 2291/0231; B29C 65/8292

(57) ABSTRACT

This invention relates to inspection techniques for use on composite joints and repairs. In this context, this invention proposes a system for inspecting a repair or joint consisting of a composite material applied to a structure, comprising at least one exciter or element that is excitable (2, 10) to a thermal and/or vibrational stimulus, the at least one exciter or excitable element (2, 10) being integrated into the repair (1) or joint.

### FIELD OF THE INVENTION

This invention relates to techniques for inspecting materials. More specifically, this invention is in relation to techniques for inspecting composite joints and repairs.

### BACKGROUND OF THE INVENTION

Composite materials are increasingly being used in various industrial segments. The aerospace sector is the area that uses this type of material the most. However, the oil, gas and energy industries are following this trend, mainly as a function of the high resistance/weight relationship, immunity to corrosion, and the possibility of “cold” application of these materials. In the oil and gas industry, the possibility of cold application of joints and repairs is quite attractive, as it eliminates the need to isolate the environment and ensure it is free of the risks of combustion and explosion.

Two types of uses for composite materials are being established in the oil, gas, and energy industries: repairs using composite materials, and structural elements produced entirely out of composite materials. The first involves applying a layer of composite material over a metal structural element, either to serve as a barrier against corrosion, or as structural reinforcement. The second type involves mainly pipes and pressure vessels made completely of composite materials.

In the oil, gas, and energy industries, the history of failures with composite materials is predominantly related to defects in assembly or problems during application of coatings in the field. This is typical of repairs and protective coatings of composites and joints between pipes made of composite materials.

In both cases, the application conditions are usually unfavorable, resulting in a higher probability that defects will occur, such as: adhesion failures (on metal-composite interface and composite-composite interfaces); delamination (adhesion failures between the layers of the composite); inclusions (presence of bubbles and foreign objects between the composite layers), and non-uniform distribution of fibers in the composite. There may also be defects in the structure arising from the component manufacturing process.

Defects in protective coatings and repairs may compromise the efficacy of the protection or structural reinforcement. If not detected and corrected, defects in joints and connections of composite pipe structures may progress and lead to operational failures, producing the risk of product leakage.

Repairing metal pipes using composite materials has grown in the field; however the lack of effective field inspection techniques greatly restricts their use. Therefore, as these materials are currently used, it is necessary to inspect the coatings applied and repairs made in the field, as well as connections and joints in structures made of composite materials.

Shearography and thermography equipment are capable of performing non-destructive inspection of composite materials. However, detecting internal defects using shearography or thermography requires the generation of a thermal gradient (excitation) inside the composite. In addition to thermal excitation, shearography may also be used with vibrational excitation to detect defects.

The current state of the art contains some repair-monitoring techniques in which sensors are inserted inside the repair so it can be monitored continuously.

Document ES2368541B1, for example, reveals a procedure for repairing metal aeronautical structures using composite material. This method comprises inserting optical fiber between the structure of the airplane and the repair that uses composite material, allowing practical inspection of the integrity of the repair.

Document CN101561400B also reveals a method for repairing structural damage to an airplane using composite material, inserting optical fiber into the repair to monitor the integrity of the repair through fiber Bragg grating (FBG). Using this technique, the repair can be monitored in real time.

However, continuous (online) monitoring techniques are very expensive, as they require a system dedicated entirely to monitoring.

In the current state of the art, therefore, there is a need for a low-cost technique that will allow repairs or joints made of composite material to be inspected using thermal and/or vibrational excitation.

As will be further detailed below, this invention seeks to resolve the problem in the state of the art described above in a practical and efficient manner.

### SUMMARY OF THE INVENTION

The main objective of this invention is to provide a low-cost, very effective system to inspect a repair or joint made of composite material applied to a structure.

In order to attain the objective described above, this invention provides a system for inspecting a repair or joint made of composite material applied to a structure, comprising at least one exciter or element that is excitable to a thermal and/or vibrational stimulus, or at least one exciter or excitable element being integrated in the repair or joint.

### BRIEF DESCRIPTION OF THE FIGURES

The detailed description presented below references the attached figures and their respective reference numbers.

FIG. 1 shows a schematic cross view of a first realization of the system of this invention in a composite repair to a pipe.

FIG. 2 shows a detailed cross view of the first realization of this invention.

FIG. 3 shows a lateral schematic view of a second realization of the system of this invention in a composite repair on a pipe.

FIG. 4 shows a cross schematic view of a third realization of the system of this invention on a composite pipe joint.

FIG. 5 shows the result of thermographic inspection from internal excitation promoted by the system according to the first realization of this invention.

### DETAILED DESCRIPTION OF THE INVENTION

First, please note that the following description will begin with the preferred realization of the invention. As will be evident to anyone skilled in the matter, however, the invention is not limited to this particular realization.

The system for inspecting a repair or joint made of composite material applied to a structure, according to this invention, comprises at least one exciter or element that is excitable to a thermal and/or vibrational stimulus, in which the at least one exciter or excitable element is integrated in the repair or joint.

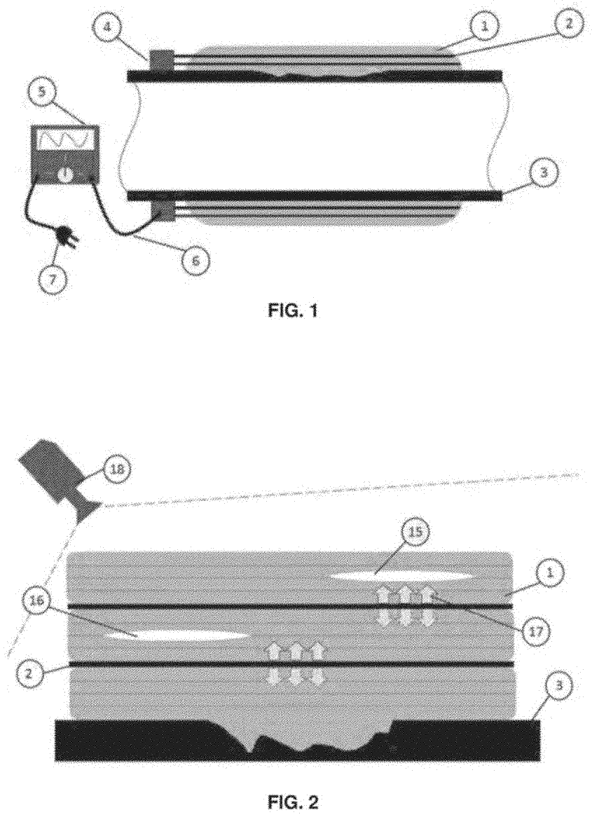

FIG. 1 shows a cross schematic view of a first realization of the system of this invention in a composite repair 1 in a pipe 3. In this first realization, applied to a composite repair 1, the excitable element is at least one layer of a material that is excitable to a thermal and/or vibrational stimulus. More preferably, this layer that is excitable to a thermal and/or vibrational stimulus is a carbon fiber layer 2.

Depending on the height of the repair, it may be necessary to use two or more layers of carbon fiber 2 to ensure excitation along the entire thickness of the composite repair 1. In the first realization, illustrated in FIG. 1, two layers of carbon fiber 2 are used.

The system of this invention may also comprise at least one thermal connector 4 adapted to connect each one of the carbon fiber layers to a voltage source 5. Thus, the carbon fiber layers are thermally excited through at least one thermal connector 4.

Preferably, a first electric cable 6 connects the thermal connector 4 to the voltage source 5. Additionally, and also preferably, a second electric cable 7 connects the voltage source 5 to the electricity network (not shown).

FIG. 2 shows a detailed cross view of the first realization of this invention. During thermal excitation (heating), the repair 1 is observed using a non-destructive inspection system 18, as illustrated in FIG. 2. The non-destructive inspection may be done by means of a shearography system, a thermographic camera, or both.

FIG. 2 also shows the bidirectional thermal flow 17 generated by the carbon fiber layers 2 integrated inside the composite repair 1. Individually heating each layer helps estimate the depths at which the defects are located 15, 16.

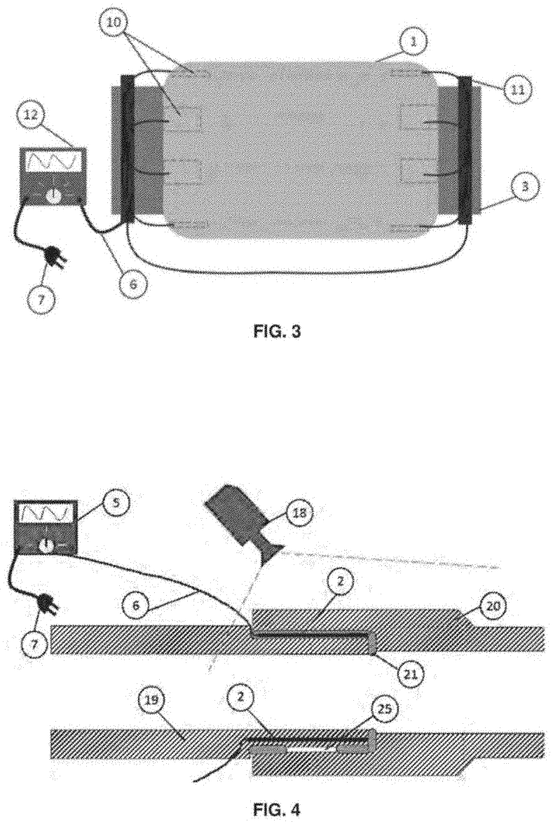

FIG. 3 shows a lateral schematic view of a second realization of the system of this invention in a composite repair 1 to a pipe 3. In this first realization, applied to a composite repair 1, the excitable element is at least one piezoelectric actuator integrated inside the composite repair 1, the actuator having been adapted to receive an external signal and to vibrate at a minimum determined frequency. More preferably, a set of piezoelectric actuators 10 are integrated in the ends of the composite repair 1, as shown in FIG. 3.

The second realization of the system of this invention may also comprise at least one vibrational connector 11 adapted to connect and send the external signal to each of the actuators. Thus, each of the piezoelectric actuators 10 is connected to the adjacent actuators. Furthermore, the vibrational connector 11 receives the signal from an amplified signal generator 12 for harmonic vibration of varied frequency. The signal that is sent to the vibrational connector 11 is distributed to the piezoelectric actuators 10.

Optionally, as shown in FIG. 3, two vibrational connectors 11 are provided, where each connector distributes the signal coming from the amplified signal generator 12 to a determined set of piezoelectric actuators 10.

Analogous to the first realization, preferably, a first electric cable 6 connects the vibrational connector 11 to the amplified signal generator 12. Additionally, and also preferably, a second electric cable 7 connects the amplified signal generator 12 to the electricity network (not shown).

FIG. 4 shows a schematic view of the system of this invention applied to a joint bonded to a composite pipe 19. The bonded joint illustrated in FIG. 4 is a bell-and-spigot type, where the bell end of the pipe 19 on the left is inserted into the spigot end 20 of the pipe on the right. In the contact between the bell 19 and the spigot 20 there is an adhesive layer 21 that secures the ends to each other. Additionally, FIG. 4 shows a possible defect 25 in the joint, characterized by the absence of adhesive at a certain point of the connection.

In the third realization, as well as in the first, at least one carbon fiber layer 2 is provided inside the joint so that it can receive an exterior thermal stimulus. Preferably, at least one layer of carbon fiber 2 is provided in the adhesive layer 21 (shown in the upper part of FIG. 4) and/or between the layers of the pipe's bell structure 19 (shown in the lower part of FIG. 4).

Similar to the first realization, preferably, a first electric cable 6 connects the carbon fiber layers 2 (optionally through a thermal connector) to the voltage source 5. Additionally, and also preferably, a second electric cable 7 connects the voltage source 5 to the electricity network (not shown).

During thermal excitation (heating), the joint is observed using a non-destructive inspection system 18, as shown in FIG. 4. Similar to the first realization, the non-destructive inspection may be done using a shearography system, a thermographic camera, or both.

Preferably, the composite material used in the repair of this invention comprises a matrix material and a reinforcement material. More preferably, the matrix material is a plastic material or a resin, while the reinforcement material may be, for example, glass fiber.

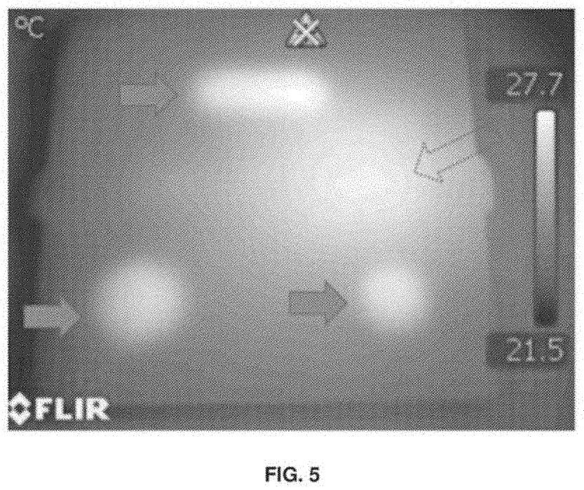

FIG. 5 shows a result obtained during a thermographic inspection done on a test body containing three internal defects (arrows with solid lines). The dotted arrow indicates the internal source of thermal excitation. The result clearly shows the presence of the three internal defects.

Thus, this invention provides a system for inspecting a repair or joint of composite material applied to a structure (piping, for example), that is low cost and that considerably improves the efficacy of thermography or shearography inspection methods.

Countless variations to the scope of protection of this application are allowed. Thus, the fact is reinforced that this invention is not limited to the specific configurations/realizations described above.

1. A system for inspecting a repair or joint made of composite material applied to a structure, the system comprising:
at least one exciter or element that is excitable to a thermal and/or vibrational stimulus, the at least one exciter or excitable element being integrated in the repair or joint.

2. The system of claim 1, wherein the composite material comprises a matrix material and a reinforcement material.

3. The system of claim 2, wherein the matrix material comprises a plastic material or a resin, and the reinforcement material comprises glass fiber.

4. The system of claim 1, wherein the exciter or the element comprises a piezoelectric actuator integrated inside the repair or the joint, wherein the actuator is adapted to receive an external signal and to vibrate at least a minimum determined frequency.

5. The system of claim 4, further comprising:
a plurality of piezoelectric actuators integrated on the ends of the repair or the joint.

6. The system of claim 5, further comprising:
at least one connector adapted to send the external signal to each of the piezoelectric actuators.

7. The system of claim 1, wherein the excitable element comprises at least one layer of a material that is excitable to a thermal and/or vibrational stimulus.

8. The system of claim 7, wherein the at least one layer comprises at least one layer of carbon fiber.

9. The system of claim 8, further comprising:
at least one thermal connector adapted to connect each carbon fiber layer to a voltage source.

10. The system of claim 2, wherein the exciter or the element comprises a piezoelectric actuator integrated inside the repair-or the joint, wherein the actuator is adapted to receive an external signal and to vibrate at least a minimum determined frequency.

11. The system of claim 3, wherein the exciter or the element comprises a piezoelectric actuator integrated inside the repair-or the joint, wherein the actuator is adapted to receive an external signal and to vibrate at least a minimum determined frequency.

12. The system of claim 2, wherein the excitable element is at least one layer of a material that is excitable to a thermal and/or vibrational stimulus.

13. The system of claim 3, wherein the excitable element is at least one layer of a material that is excitable to a thermal and/or vibrational stimulus.
